(19) United States
(12) Patent Application Publication
(10) Pub. No.: US 2025/0174389 A1
(43) Pub. Date: May 29, 2025

(54) INDUCTOR STRUCTURE FOR MEDIUM VOLTAGE INSULATION

(71) Applicant: Delta Electronics, Inc., Taipei (TW)

(72) Inventors: Anup Anurag, Durham, NC (US); Ruxi Wang, Durham, NC (US); Peter Mantovanelli Barbosa, Durham, NC (US)

(21) Appl. No.: 18/519,893

(22) Filed: Nov. 27, 2023

(51) Int. Cl. H01F 27/24; H01F 3/14; H01F 27/32

(52) U.S. Cl. CPC H01F 27/24; H01F 3/14; H01F 2027/329

(57) ABSTRACT

The present disclosure provides an inductor including plural cores, each of the plural cores including a center post, the plural cores separated from each other by corresponding first gaps, each of the first gaps dimensioned to enable a flux path with a value that is one-half a value of the flux through one of the center posts.

### FIELD OF THE INVENTION

This present disclosure relates to a matrix-based inductor design with medium voltage insulation. More specifically, this invention relates to an inductor structure for use in medium and high voltage applications.

### BACKGROUND OF THE INVENTION

The development of power semiconductor devices using wide bandgap materials, such as Silicon Carbide (SiC), has ushered in a new era in power conversion. With the use of these materials, it is now possible to have power devices with high blocking voltage and a reasonable on-state resistance while switching at high frequencies. The inherent advantages of these devices have led many industries to start migrating towards SiC-based power semiconductor devices.

These SiC power devices have led to widespread research in the field of medium voltage solid-state transformers. Medium voltage solid-state transformers are a lucrative solution for various applications like electric vehicle (EV) charging infrastructure, data center power supplies, grid interconnection, etc. A major advantage offered by the solid-state transformer, as compared to conventional line frequency transformers (the current solution), is a reduction in the size of the power conversion stage while bringing along a slew of other advantages like reactive power control, renewable energy integration, etc. The reduction in size for the solid-state transformer is mainly achieved by the conventional line frequency transformer being replaced by a high frequency transformer. Additionally, a power electronics interface is needed to integrate this high frequency transformer to the grid. The power electronics interface, along with the high frequency transformer, can be collectively referred to as a solid-state transformer. Generally, these solid-state transformers have AC/DC stages, and DC/DC stages. The AC/DC stages are used for integrating the solid-state transformer to the grid, and the DC/DC stage helps in providing the required galvanic isolation. For integrating the power electronics interface to the grid in the AC/DC stage, typically an inductor is used to filter out the high frequency current components generated by the power electronics interface. Depending on the topology used for the DC/DC stage, inductors are also used for power conversion. Due to the high frequency operation of the converters, these inductors typically carry high frequency currents through them. In medium voltage systems, these inductors are used to block medium voltage levels, and have medium voltage insulation across them. Reliable medium voltage insulation can be achieved by not only designing the system to block the voltage, but by having a partial discharge free operation to avoid degradation in the insulation structure. Accordingly, the insulation is typically designed to ensure that the electric field in the system (or the surrounding air) does not exceed their rated values for the operating voltage (with some margin).

Medium voltage inductor systems have been used in power systems for many years. Similar to the conventional transformer, which operates at line frequency, these inductors are also conventionally designed for line frequency operation, especially in high power applications. As explained above, the introduction of SiC technology enables high frequency converter operations, yet medium voltage inductor technology for line frequency operation does not translate well to medium or high frequency operations. For instance, due to the low frequency nature of the current through these medium voltage inductors, generally these inductors are bulky in size, and power density for typical applications is not a major focus. Materials like silicon steel are used for the core, along with solid copper windings. In these inductors, the medium voltage insulation is achieved by encapsulating the solid copper windings with an insulation material, and providing enough air gap spacing within the winding and the core to achieve the medium voltage insulation.

In medium voltage, medium frequency inductors, the use of silicon steel for the core and solid copper windings is discouraged for at least two reasons. With medium frequency operation, solid copper windings and cores of silicon steel cannot be used due to their high losses at medium frequency operation. For instance, solid copper for medium/high frequency applications is not used due to a phenomenon called the skin effect. Due to this effect, the effective area of cross section of the solid copper winding is reduced for medium/high frequency currents, since the currents start flowing only at the surface of the windings. This leads to an increase in the effective resistance of the winding, and consequently, increased losses. Materials like silicon steel have a high saturation flux density, which allows them to operate at high peak flux values, but the core loss due to the flux swing is high. Since the core loss is high, higher frequency operation increases the core loss dramatically and renders silicon steel or similar materials unusable and/or disfavored for such applications.

Also, most of the applications that deal with medium frequency inductors (like solid-state transformers) focus on the power density of the magnetic components. Due to this focus, the magnetic component cannot be made arbitrarily big by providing air gaps for medium voltage insulation.

To mitigate the problems seen by existing inductor designs, certain methods have been developed for low voltage applications (e.g., <2 kV). For instance, silicon steel cores can be replaced by other materials such as ferrite, nano-crystalline or amorphous cores, which offer lower core losses, thus enabling high frequency operation. The replacement of solid copper windings may come in the form of litz wires, which are designed for medium/high frequency operation. The parameters of the litz wire need to be determined based on the frequency of operation, but the structure of the litz wires is made such that the skin effect for particular frequencies is eliminated (or substantially eliminated) and the AC resistance is minimized. However, medium voltage inductors (e.g., greater than approximately 3.3 kV) require additional insulation requirements and necessitate partial discharge free operation (to have continuous and reliable operation). Achieving good efficiencies and power density while having reliable medium voltage operation still remains a big challenge.

A lot of work has been carried out in the literature for medium voltage inductor and transformer designs. The most basic method of designing an inductor and achieving the required voltage isolation is to follow the conventional design process and provide a gap between the core and the windings, and also between the layers of each of the windings, as shown in FIG. 1 (which includes FIG. 1A (front view) and 1B (top view of one of the windings)). In particular, FIG. 1 shows an inductor 10 including a core 12 (shown in FIG. 1A including a core pair that includes a top and bottom portion separated by a gap 14, with one leg or post shown in FIG. 1B) and a winding assembly 16 around each (left and right) leg or post. The winding assembly 16 includes a winding support structure (or also simply referred to herein as a support structure) that includes support for multiple winding layers. For instance, the winding support structure depicted in FIG. 1 includes a bobbin support 18 and supports 20 (20a, 20b) that are separated from each other and the bobbin support 18 by spacers 22. The support 20a supports one winding layer 24 and support 20b supports another winding layer 26. Note that air gaps are denoted by white space between the various structures, which in some circumstances may be filled with potting material for applications where encapsulation is used. The medium voltage insulation is achieved by using the bobbin support 18, though in some applications, the bobbin support 18 may be replaced with other support structures (e.g., a sheet or sheets of paper, such as Nomex or Mica paper). In a variation of the structure, the windings and/or the cores can be encapsulated or filled with oil to reduce the air gap distance or increase the medium voltage insulation capability. However, generally, oil-filled inductors/transformers are not preferred due to the environmental concerns and/or risk of fire, and hence dry-type insulation is preferred. In applications where the inductor 10 carries primarily low frequency currents, solid copper windings may be used, and hence encapsulation (or dry-type insulation) is a viable option. However, if litz wires are used (e.g., in high frequency designs), the encapsulation process is typically not reliable and not used. In case the insulation is handled in air without encapsulation, scalability to higher voltage and a partial discharge free operation becomes difficult.

### SUMMARY OF THE INVENTION

In accordance with one embodiment of the present disclosure, there is provided an inductor including plural cores, each of the plural cores including a center post, the plural cores separated from each other by corresponding first gaps, each of the first gaps dimensioned to enable a flux path with a value that is one-half a value of the flux through one of the center posts.

These and other aspects of the invention will be apparent from and illustrated with reference to the embodiment(s) described hereinafter.

### BRIEF DESCRIPTION OF THE DRAWINGS

Many aspects of the invention can be better understood with reference to the following drawings, which are diagrammatic. The components in the drawings are not necessarily to scale, emphasis instead being placed upon clearly illustrating the principles of the present invention. Moreover, in the drawings, like reference numerals designate corresponding parts throughout the several views.

FIG. 1A and FIG. 1B show an inductor/transformer solution that achieves the required insulation by providing spacing between the windings and also between the windings and the core.

FIG. 2A and FIG. 2B show a concept of splitting one medium voltage inductor into a number of series connected inductors.

FIG. 3 is a schematic diagram that shows the series connected inductors of FIG. 2A and FIG. 2B along with the flux path through each core.

FIG. 4 is a schematic diagram that shows the cores from FIG. 3 being placed right next to each other and connected (without air gaps between the cores).

FIG. 5 is a schematic diagram that shows a concept for reducing the total volume of the series connected inductor structure of FIG. 4 by combining the cores, and eliminating some core legs.

FIG. 6 is a schematic diagram that shows one embodiment of an example inductor.

FIG. 7 is a schematic diagram that shows an example reluctance model of the inductor shown in FIG. 6.

FIG. 8 is a schematic diagram that shows another embodiment of an example inductor.

FIG. 9 is a schematic diagram that shows an example reluctance model of the inductor shown in FIG. 8.

FIG. 10 is a schematic diagram that shows another embodiment of an example inductor.

FIG. 11 is a simulation graphic that shows the flux density distribution for the inductor of FIG. 10.

FIG. 12A and FIG. 12B schematically show two different ways in which some example inductors can be realized.

FIG. 13 is a schematic diagram that shows one example method for achieving high voltage insulation required between the individual cores while increasing the clearance and creepage between the high voltage potentials.

FIG. 14 is a schematic diagram that shows another example method for achieving required high voltage insulation between the individual cores while increasing the clearance and creepage between the high voltage potentials and while maintaining partial discharge free operation.

FIG. 15 is a schematic diagram that shows one example method of increasing the thickness of the insulation sheet external to the gap if the insulation sheet within the gap is insufficient to meet required performance criteria.

FIG. 16 is a schematic diagram that shows an example method for achieving high voltage insulation by encapsulation of the portion of the core closest to each other.

### DETAILED DESCRIPTION OF THE PREFERRED EMBODIMENTS

Certain embodiments of a matrix-based, medium voltage inductor (hereinafter, also simply referred to as an inductor or matrix-based inductor) are disclosed that may offer a partial discharge free design without the need for additional encapsulation, and which use a non-unified core structure with reduced volume. In one embodiment, the matrix-based inductor limits the electric field in air to less than the breakdown voltage of air at operating voltage levels to create a partial discharge free operation. The structure can take advantage of the use of litz wire to achieve low loss and better thermal performance since the windings do not need to be encapsulated. This structure gives a modular approach for designing medium voltage inductors since multiple cores and windings are used. It also offers a reduced overall volume as compared to series-connected core structures.

Note that reference herein to a “non-unified” core structure refers to a core structure for the medium/high voltage inductor that can be at different potentials, unlike a “unified core” where, since the core is continuous, the potential of the entire core remains the same.

As explained above, typically, achieving medium voltage insulation is challenging in converter systems. A number of methods have been proposed to build a medium voltage inductor, and while some of the methods offer good performance in terms of efficiency and partial discharge free operation, they are not easy to manufacture on a mass scale, and/or they are embodied as non-modular solutions. To alleviate certain issues in designing medium voltage inductors, some embodiments of matrix-based medium/high voltage inductors are described herein, which may offer significant benefits over existing designs. In one embodiment, the matrix-based medium/high voltage inductor as disclosed herein offers a high efficiency, modular, encapsulation-free solution. Since a modular nature of the inductors is preferred in some embodiments, single core (or even unified core) structures are excluded from consideration.

Note that reference herein to medium voltage is intended to include voltage values or a voltage range that is generally accepted in the power converter industry, and in some embodiments, includes voltages greater than approximately 3.3 kV to 22 kV, with high voltage considered higher than this range.

Having summarized certain features of some embodiments of matrix-based inductors of the present disclosure, reference will now be made in detail to the description of a matrix-based inductor as illustrated in the drawings. While a matrix-based inductor will be described in connection with these drawings using a certain number of cores and/or winding layers, there is no intent to limit it to the embodiment or embodiments disclosed herein. For instance, the embodiments described herein may likewise be applied to inductor structures with different quantities of cores and/or winding layers. Also, though emphasis is placed on medium voltage inductors, it should be appreciated by one having ordinary skill in the art in the context of the present disclosure that high voltage inductors may also realize a benefit, and hence are contemplated to be within the scope of the disclosure. Further, although the description identifies or describes specifics of one or more embodiments, such specifics are not necessarily part of every embodiment, nor are all of any various stated advantages necessarily associated with a single embodiment. On the contrary, the intent is to cover alternatives, modifications and equivalents included within the principles and scope of the disclosure as defined by the appended claims. For instance, two or more embodiments may be interchanged or combined in any combination. Further, it should be appreciated in the context of the present disclosure that the claims are not necessarily limited to the particular embodiments set out in the description.

The concept of the matrix-based medium voltage inductor may be described based on series-connected, low voltage inductors. In general, series-connected, low voltage inductors are the result of dividing a medium voltage inductor into smaller, low voltage inductors and connecting them in series. This method gives a lot of benefits in terms of modularity of the structure, as well as insulation capability, since these inductors need to block a lower amount of voltage across them. In some embodiments, it should also be noted that connecting the cores to the ground is not carried out, since it defeats the purpose of having a series-connected structure, and each inductor would still need medium voltage insulation between the windings and the core. The cores can either be left floating, or can be connected to one of the inductor terminals (to define the core potential). Apart from modularity, this solution also has a few distinctive benefits, including that potting or encapsulation may not be required since each of the inductors can be considered as individual low voltage inductors. This design also enables the use of litz wires in such structures since the windings do not need to be potted. In some embodiment, since the cores might be floating (or at high voltage potential), adequate considerations (e.g., for placement of the actual ground plane) are needed to mount these inductors. Also, the overall volume of the series-connected structure is typically larger than a single medium voltage inductor.

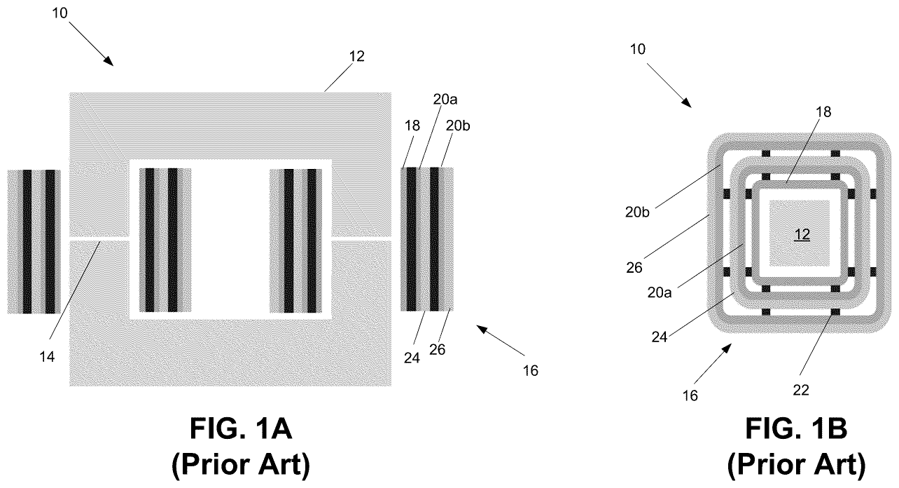

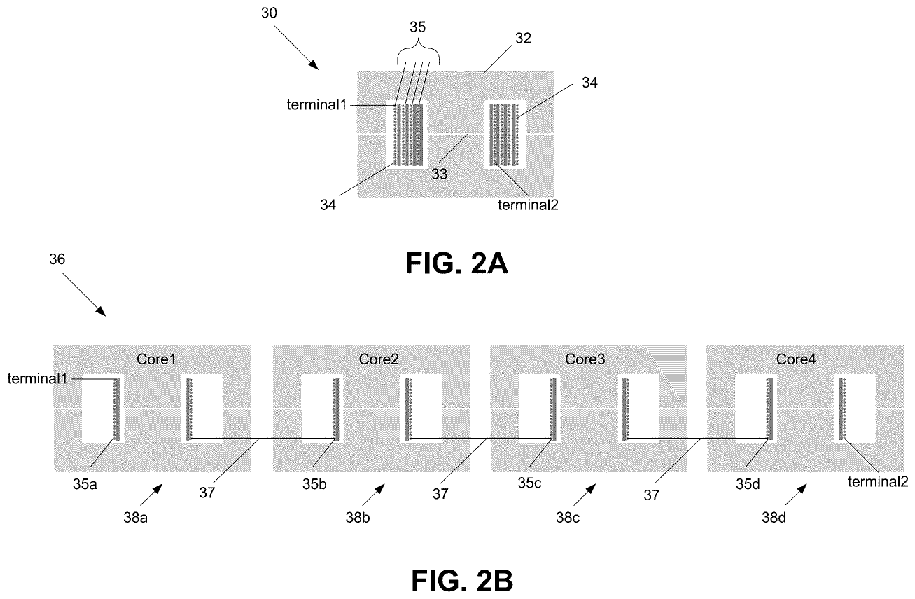

Explaining series-connected inductor structures further, attention is directed now to FIG. 2A, front view of a single inductor, and FIG. 2B, front view of a series-connected inductor structure, showing the concept of splitting one medium voltage inductor into low voltage series-connected inductor structures. Referring to FIG. 2A, a single, medium voltage inductor 30 is shown with a core 32 that includes a core pair having a top portion and a bottom portion separated by a gap 33. In general, a core structure includes a top post, a center post, a bottom post, and two side posts. Note that posts are sometimes referred to as legs. The core 32 further includes a winding assembly 34. The winding assembly 34 includes a support structure (which may include a bobbin support) that supports plural winding layers 35 that spiral around or encircle the center post (somewhat similar to that shown and described in FIG. 1). The example inductor 30 shown here has four winding layers 35 with N turns total, and further has an inductance of Land an area of cross section of the center post of Ac.

For achieving the same equivalent inductance of L in a series-connected structure, the area of cross section of the cores needs to be the same and the windings can be divided as shown in the example series-connected inductor structure 36 of FIG. 2B (N/4 on each of the inductors for series-connection 37 of four inductors 38 (e.g., 38a, 38b, 38c, and 38d)). For this series connection, it can be seen that the volume of the single core 32 of FIG. 2A becomes four times, since four smaller inductors 38 with separate cores 1-4 are used. In this example, inductor 38a includes winding layer 1 35a, inductor 38b includes winding layer 2 35b (connected via series connection 37 to winding layer 1 35a), inductor 38c includes winding layer 3 35c (connected via series connection 37 to winding layer 2 35b), and inductor 38d includes winding layer 4 35d (connected via series connection 37 to winding layer 3 35c). This structural arrangement leads to increased volume and increased core losses of the inductor structure 36. In the single inductor 30, for a medium voltage application, the insulation of the inductor needs to be designed accordingly. For withstanding a voltage of Vmax, the insulation between the windings, as well as the insulation between the windings and the core, should be designed for a value of Vmax. For medium voltage applications, the Vmax is typically high and is difficult to design for such high insulation levels. This is one of the features for which the series-connected inductor structure 36 has an advantage. For instance, since the inductor 30 of FIG. 2A is divided into four inductors 38 (FIG. 2B) connected in series, each of the inductors 38 is designed to block only Vmax/4 voltage, and the insulation can be designed accordingly. In some examples, one of the constraints in using these series-connected inductor structures 36 is that the cores should not be grounded. In case the core is grounded, the series-connected inductor structure still needs to achieve the medium voltage insulation between the windings and the core. The cores might either be left floating (without connection to a potential) or might be tied to the potential of one of the local terminals. It should be noted that in case the cores are connected to the potential of the local terminal, it should be ensured that all the cores are connected to their respective lower voltage or higher voltage terminal (i.e., either all of the lower or all of the higher potentials, depending on the selected connection). In addition to the lower insulation requirements, the series-connected structure also offers additional advantages in terms of the parasitic capacitance. Since four identical inductors are connected in series, it helps in enabling a significant reduction in the parasitic capacitance (e.g., a capacitance of C/4 in FIG. 2B versus C in FIG. 2A for this example).

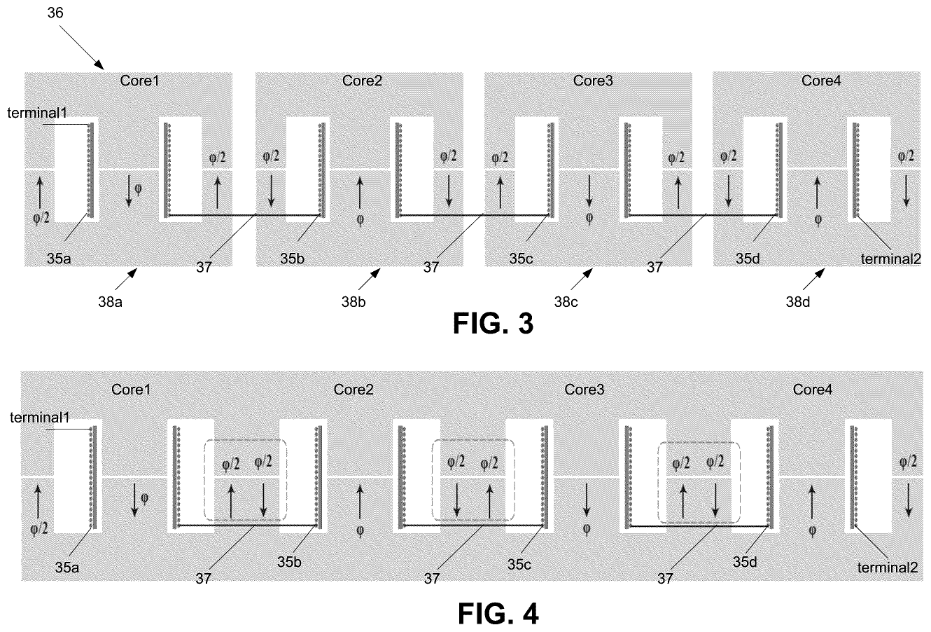

A matrix inductor addresses the fact that series-connected inductors have a higher volume and consequently, a higher core-loss. For instance, and referring to FIG. 3, the series-connected inductor structure 36 of FIG. 2 is shown in FIG. 3 (with like components similarly referenced) with the path of the flux through each of the series connected inductors 38 added to the figure. It merits noting that there is no flux in the gaps between each core. Based on how the series connection is carried out, the direction of the flux path can be changed.

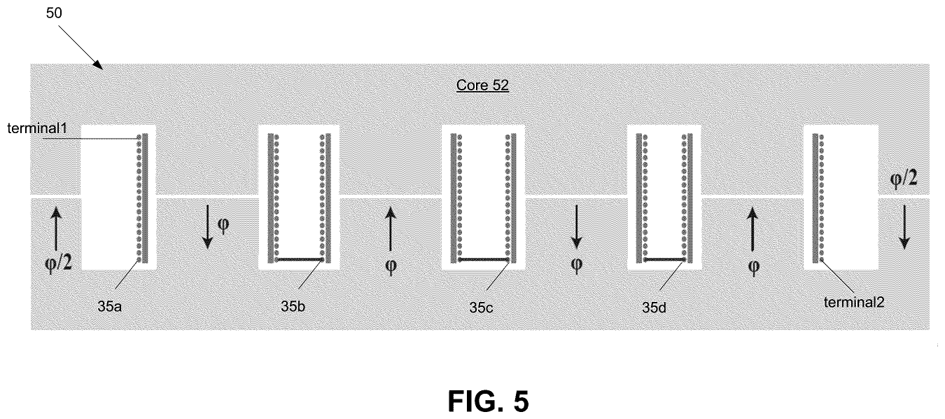

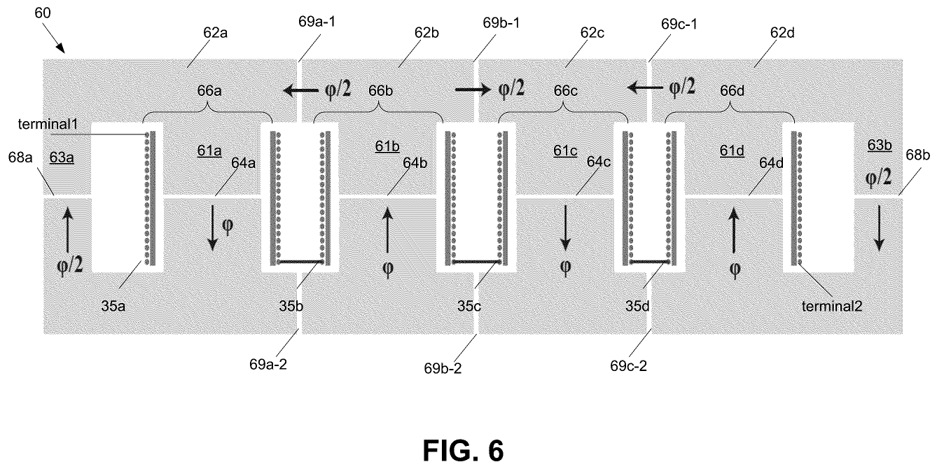

In FIG. 4, which again shows like-referenced features to that shown in FIGS. 2B-3, the cores of the series-connected inductors 38 of FIG. 4 are arranged adjacent to each other by removing the gap between the cores). Notably, FIG. 4 shows that the flux is cancelled in those areas or legs where the gap of the cores was removed. If those legs where the flux is cancelled are combined, there would be zero flux in those legs. Since there is no flux in those legs, they can be eliminated, which results in a matrix inductor 50 as shown in FIG. 5. The matrix inductor 50 includes a core 52 having a single core pair (top and bottom), and the winding assemblies including the various winding layers 35. The core 52 may be referred to as a unified core structure (where the core is at the same potential everywhere within the core), and which is smaller in volume when compared to the structure including the series-connected inductors 38 described above (FIG. 2B). The flux directions, as well as the magnitude, can be designed based on the desired requirements by changing the air gaps. Ideally, the required inductance remains the same as L if the air gap is designed accordingly. From a structural perspective, it should be noted that since the core 52 is a unified structure, to achieve a medium voltage insulation, the insulation between the windings and the core should be designed for the maximum voltage Vmax. This effect of transitioning from a non-unified to unified core negates one of the important advantages of using series-connected inductors for medium voltage applications. However, this arrangement of the matrix inductor 50 may be beneficially used in low voltage applications, mainly to reduce the parasitic capacitance across this inductor.

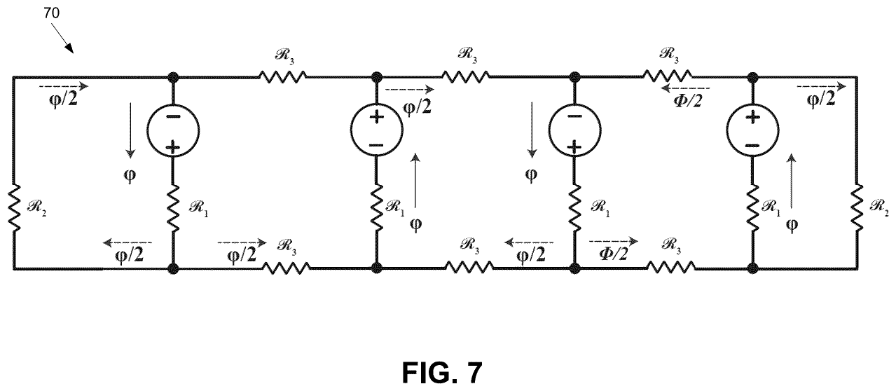

FIG. 6 shows an embodiment of an example matrix-based inductor 60, in accordance with an embodiment of the present invention. The matrix-based inductor 60 includes a single, medium voltage inductor that uses a medium voltage matrix inductor concept with four center legs or center posts 61 (e.g., 61a, 61b, 61c, and 61d). The number of center posts 61 is not fixed and depending on the requirements, a different number of center posts 61 can be determined. In particular, the matrix-based inductor 60 includes plural cores 62 (e.g., 62a, 62b, 62c, 62d). Each of the plural cores 62 includes a core pair including a top portion and a bottom portion, separated by a respective center post gap 64 (e.g., 64a, 64b, 64c, and 64d). Also shown are plural winding assemblies 66 (e.g., 66a, 66b, 66c, and 66d). In one embodiment, each of the winding assemblies 66 includes a bobbin support with a respective winding layer and winding layer support (the winding layer support also referred to herein as simply a support), though in some embodiments, a sheet or sheets of paper (e.g., Nomex paper or Mica paper) may be used as a support structure (e.g., in lieu of a bobbin support). For instance, winding assemblies 66a, 66b, 66c, and 66d include winding layer 1 35a, winding layer 2 35b, winding layer 3 35c, and winding layer 4 35d, respectively. In the depicted embodiment, the support structures of the winding assemblies 66 support the winding layers 35. The winding layers 35 encircle the center posts 61 of the cores 62. For instance, winding layer 1 35a encircles the center post 61a. Winding layer 2 35b encircles the center post 61b. Winding layer 3 35c encircles the center post 61c. Winding layer 4 35d encircles the center post 61d. The matrix-based inductor 60 further includes two side posts 63 (63a, 63b) with respective side post gaps 68a and 68b that are collinear with the center post gaps 64.

The matrix-based inductor 60 further includes core gaps 69 (e.g., 69a-1, 69b-1, and 69c-1 shown at the top, and corresponding gaps 69a-2, 69b-2, and 69c-2 shown beneath the respective top core gaps) that are arranged in between adjacent cores 62 in the top and bottom portions. For instance, the core gaps 69a-1 and 69a-2 are shown in FIG. 6 oriented along an axis that runs vertically, between the cores 62a and 62b, in the top and bottom portions, respectively. Explaining further, the core gap 69a-1 runs vertically between the top portion of core 62a and the top portion of core 62b. The core gap 69a-2 runs vertically between the bottom portion of core 62a and the bottom portion of core 62b. Though the core gaps 69a-1 and 69a-2 are aligned along a vertical axis, they are separated by an insulated space that includes a portion of adjacent winding assemblies. For instance, the core gaps 69a-1 and 69a-2 are separated by an insulated space that includes a portion of winding assembly 66a (that includes winding layer 1 35a) and a portion of winding assembly 66b (that includes winding layer 2 35b). As noted from FIG. 6, a flux path (of a given flux value, φ) is established through the center posts 61 (e.g., each having flux value, φ of a given direction or polarity) and also across the core gaps 69 (e.g., each of a flux value, φ/2 of a given direction or polarity) on each side of the center posts 61. For instance, a flux path (e.g., of flux value, φ) is established through center post 61b of core 62b and through core gap 69a-1 (e.g., of flux value, φ/2) to core 62a and core gap 69b-1 (e.g., of flux value, φ/2) to core 62c. No flux path is established through the insulated space. In similar manner, core gaps 69b-1 (and 69b-2) separate cores 62b and 62c, and core gaps 69c-1 (and 69c-2) separate cores 62c and 62d. Further, core gaps 69 are oriented in a direction orthogonal to the center post gaps 64 and, in the depicted embodiment, side post gaps 68.

In one embodiment, the winding assemblies 66 include litz wires that enclose or encircle the center posts 61 of the magnetic cores 62. Depending on the application requirements, PCB based windings may be used. As shown, a non-unified concept of magnetic cores 62 is used, where the core gaps 69 are dimensioned to achieve the required inductance, as well as to provide the necessary voltage isolation between the cores 62. The value of the core gaps 69 depends on the required inductance as well as the needed voltage isolation. For instance, during the design stage of such an inductor 60, an additional requirement of voltage isolation should be considered while determining the design of the inductor.

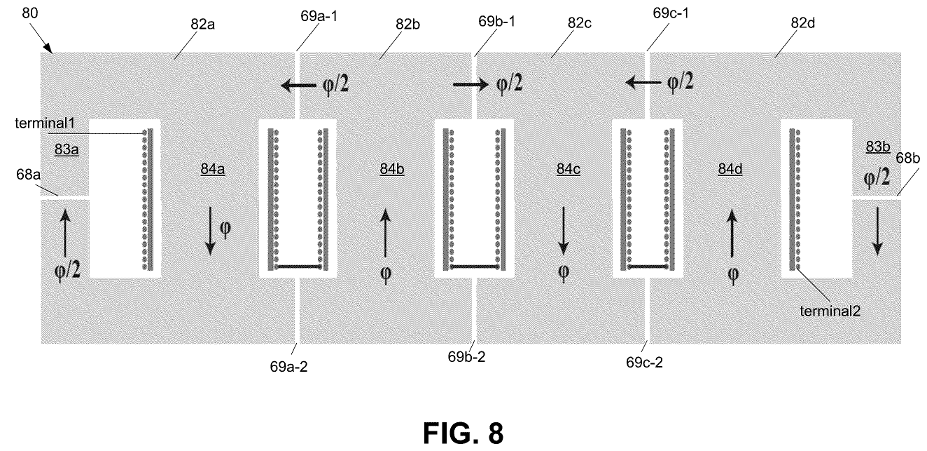

FIG. 7 shows a reluctance model 70 of the medium voltage medium matrix-based inductor 60 (shown in FIG. 6). The reluctance R1, R2 and R3 may be determined by the length of the air gaps and the area of cross section of the inductor center post 61, Ac. R1 corresponds to the four center post gaps 64, R2 corresponds to the side post gaps 68, and R3 corresponds to the top and bottom core gaps 69. Based on the model 70 of FIG. 7, the reluctance R1 is given by

$$R 1 = \frac{lg 1}{{μ}_{0} Ac}$$

### Similarly, the Reluctance R2 is Given by

$$R 2 = \frac{2 lg 2}{{μ}_{0} Ac}$$

### And R3 is Given by

$$R 3 = \frac{2 lg 3}{{μ}_{0} Ac}$$

where lg1, lg2 and lg3 are the respective lengths of the corresponding air gaps, and Ac is the area of cross section of the center posts 61, and Ac/2 is the area of cross section of the side posts 63 as well as the top and bottom posts as shown in FIG. 7. Since the windings are wound on the center posts 61, flux source (with correct polarity) are as shown in the reluctance model in FIG. 7. The reluctance R3 needs to be equal to R2 to maintain the flux distribution as shown in FIG. 7 (the flux through the side posts 63 is shown to be equal to the top and bottom posts). From observance of FIG. 7 (and FIG. 6), it is notable that the flux across core gaps 69 is equal to one-half the flux value through the center posts 61. For instance, in the depicted embodiment, the value of the flux through one core gap 69 (e.g., 69a-1) is one-half the value of the flux through a center post 61 (e.g., center post 61b). This is a preferred condition for the dimensioning and operation of the medium voltage matrix inductor. The values of the reluctances R1, R2 and R3 can be designed based on the required inductance, peak flux density and area of cross section.

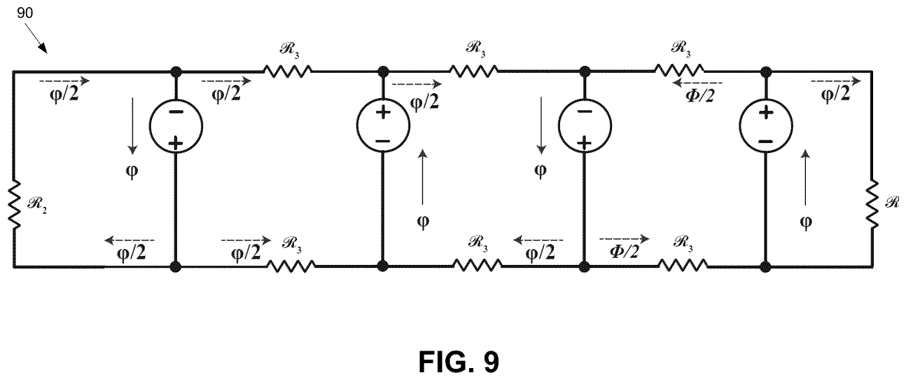

FIG. 8 shows another embodiment of a matrix-based inductor 80, which is a variation of the matrix-based inductor 60 shown in FIG. 6, where the reluctance R1=0. The matrix-based inductor 80 includes cores 82 (e.g., 82a, 82b, 82c, and 82d), center posts 84 (e.g., 84a, 84b, 84c, and 84d), and side posts 83 (e.g., 83a, 83b), somewhat similar to that shown in FIG. 6. Note that winding assemblies are shown yet un-referenced, with a similar description as in FIG. 6, and hence discussion of the same is omitted here for brevity. Note that, in FIG. 8, the center post gaps 64 (FIG. 6) are removed. Preferably, a medium voltage matrix-based inductor, such as that shown in FIG. 8, should have the side post (air) gaps 68 on the side posts 83, and core (air) gaps 69 on the top and bottom posts, to handle the voltage insulation. These air gaps 68, 69 are also used to provide the needed inductance. Removing the center post air gaps 64 (FIG. 6) makes the design and manufacturing easier since it reduces the total number of air gaps required. It should be noted that the manufacturing of the matrix-based inductor 80 does not necessitate center posts 84 (e.g., 84a, 84b, 84c, and 84d) to be a single piece since it might create difficulties for some automation assemblies. In some embodiments, the center post 84 may include two or more pieces, and the gap between these pieces may be much smaller than the core gap 69 to keep the reluctance R1 close to 0.

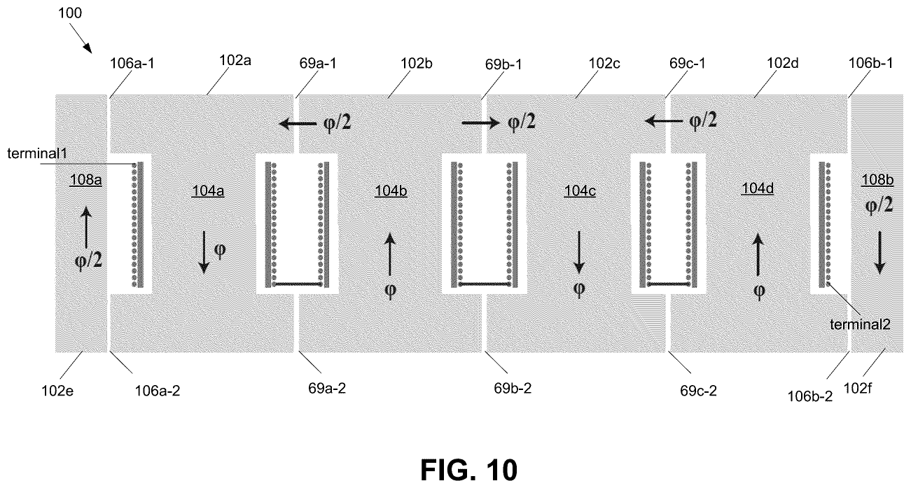

FIG. 9 illustrates a reluctance model 90 of the medium voltage, matrix-based inductor 80 shown in FIG. 8. The reluctance of R1=0 can be replaced by a shorted-connection, as shown. The flux distribution can be kept the same as that shown in FIG. 6 by modifying the reluctances R2 and R3 according to the required inductance, area of cross section and the peak current through the windings. Again, it is notable that in this embodiment the flux across the core gaps 69 is one-half the value through the center posts 84, as similarly described above for FIGS. 6-7.

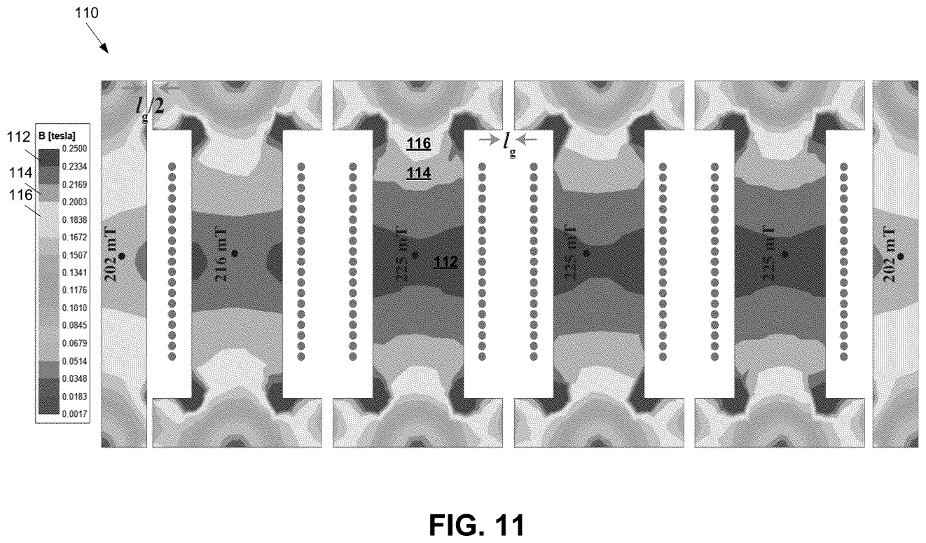

FIG. 10 shows yet another embodiment of a matrix-based inductor 100, and reveals a variation of the matrix-based inductor 80 of FIG. 8. Somewhat similar to FIGS. 6 and 8, the matrix-based inductor 100 includes plural cores 102 (e.g., 102a, 102b, 102c, and 102d) with respective center posts 104 (e.g., 104a, 104b, 104c, and 104d), as well as the core gaps 69 separating adjacent cores. Additional side cores 102e and 102f are arranged at opposing ends of the inductor 100, each with side posts 108 (e.g., 108a, 108b). It can be seen in FIG. 8 that the side posts 83 contain a single air gap 68, which leads to a complicated shape of the core for the two end parts of the medium voltage, matrix-based inductor 80. This arrangement may not be preferable due to manufacturing complexity. FIG. 10 illustrates that the matrix-based inductor 100 includes a symmetrical structure of the individual cores where the side gaps 68 of FIG. 8 are replaced with side gaps 106 (e.g., 106a-1, 106b-1 for the top portion, 106a-2, 106b-2 for the bottom portion), which are oriented parallel to the core gaps 69. In effect, the cores 102 may need essentially two simple core shapes (for 102a-102d and 102e-102f) to realize the entire structure. In the embodiment, the cross sections of the side cores 102e and 102f are rectangle, and cross sections of the cores 102a, 102b, 102c, and 102d are I-shaped. Similar to FIG. 8, for manufacturing the center posts 104, two or more pieces can be used to realize the structure, but the air gap might need to be minimized such that R1 is close to 0. Also, as similarly explained for FIG. 8, FIG. 10 shows but omits reference to the winding assemblies, where the description is as described in association with FIG. 6 and hence omitted for brevity. Similar to the embodiments described above, the value of the flux across the core gaps 69 is one-half the value through the center posts 104.

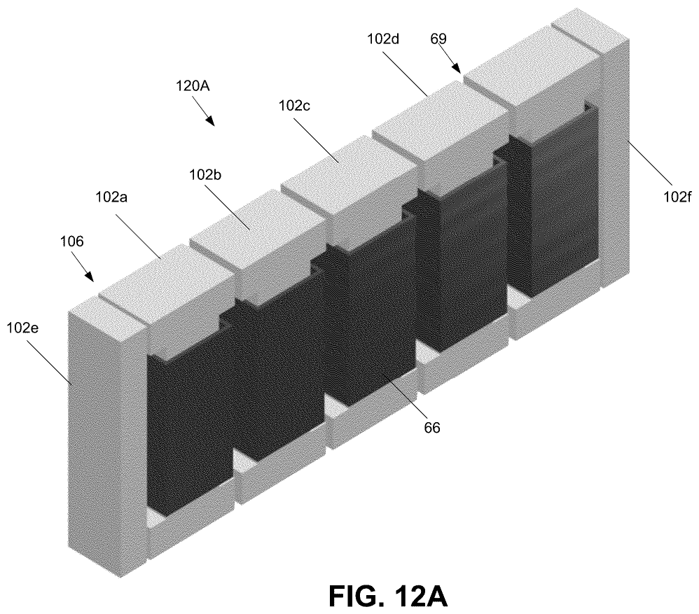

FIG. 11 shows a simulation of a flux density distribution 110 for the matrix-based inductor 100 as shown in FIG. 10 with a specific number of turns (N=19), current (I=18 A) and specific airgaps lg and lg/2. It can be noted that the flux density through each of the center posts 104 and the side posts 108 are similar to each other (200 mT-220 mT), with some example shading differences shown via tesla level labels 112, 114, and 116 to provide context according to the legend to the left in FIG. 11. In this figure, with continued reference to FIG. 10, the cross-section area (Ac) of the center posts 104 is twice the cross-section area (Ac/2) of the side posts 108 and top and bottom posts. This distribution is possible only when the air gap for the center posts (lg) is twice that of the air gap of the side post, as shown in the figure, which substantiates the explanation above in conjunction with FIG. 6 that if the reluctance R3 equals R2, the flux density through each of the posts will be similar, and depending on the area of cross-section, the flux through each of the posts can be determined.

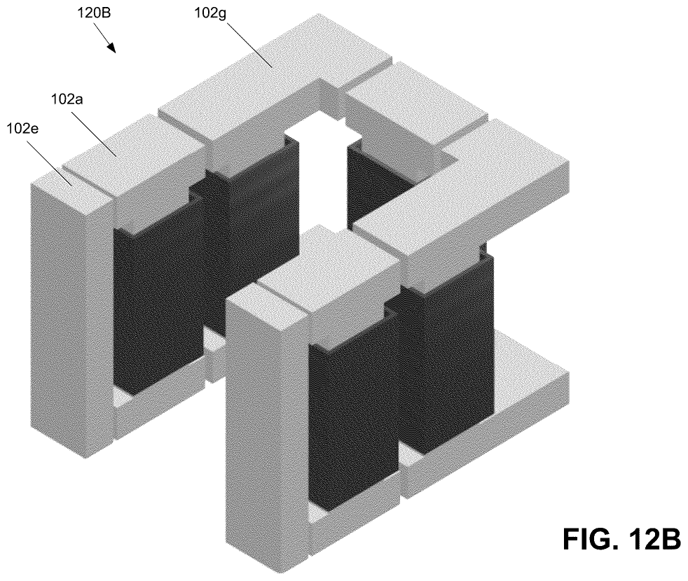

FIG. 12 (which includes FIGS. 12A, 12B) shows two methods for physically realizing the medium voltage, matrix-based inductors described above. Referring to FIG. 12A, shown is a matrix-based inductor 120A, similar to that shown for FIG. 10, with an arrangement of the cores 102 (e.g., 102a, 102b, 102c, and 102d with their corresponding core gaps 69, and side cores 102e, 102f with their respective gaps 106) and their respective winding assemblies 66, in a single file or linear arrangement. In the embodiment, the design may give the minimum total volume of the inductor 120A and necessitates the use of just two types of simple core structures (one type associated with each of cores 102a-10d, and another type associated with each of cores 102e-102f). However, in some cases, the linear structure might not be suitable, such as when the installation environment has shorter, more cubicle-like or generally, compact dimensions. Another arrangement is shown in FIG. 12B, where the matrix-based inductor 120B is based on the design of the matrix-based inductor 120A yet the cores 102 are arranged into a folded or non-linear structure, such as a U-shaped structure. In this design, the whole inductor structure is more cubical, even if the total volume of the inductor 120B is greater than that of the inductor 120A of FIG. 12A. Also, the inductor 120B may need three different types of core structures (e.g., 102a, 102e, and newly introduced 102g), as shown in FIG. 12B. As suggested above, one benefit to using the inductor 120B (e.g., over inductor 120A) is that the inductor 120B may permit installation in spaces that require a more compact design.

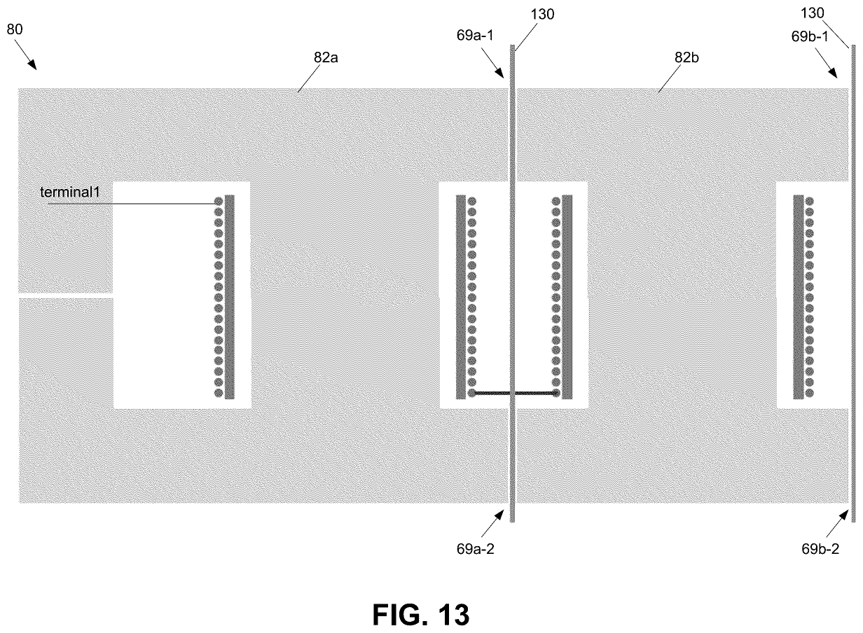

According to the various embodiments of a matrix-based inductor as described above, the cores can be made in a non-unified structure (e.g., plural cores at different potentials) and the air gaps between each of the cores can be used to achieve the required insulation. FIGS. 13-16 show some example methods for increasing the clearance and creepage while maintaining the high voltage insulation.

However, before commencing description of these various methods, a brief discussion of existing technology and certain shortcomings to these approaches is described below. In some designs, encapsulation of particular parts of the inductor may be carried out. For instance, the winding of the inductor is encapsulated, a shielding layer is provided on the surface to ensure that the electric field in the air is limited to less than 2 kV/mm, and the encapsulant material withstands the high electric field. Such designs may provide a partial discharge free operation, yet may also present some downsides. For instance, the structure should be potted, and steps taken to ensure there are no air bubbles inside the encapsulating structure. Also, the shielding layer generally increases the parasitic capacitance of the inductor structure. Some existing designs for a planar structure, high frequency transformer provide for shielding of the windings for a PCB based structure, where a terminal treatment (e.g., encapsulation at the edge of the shielding layer) is added to eliminate possible surface partial discharge scenarios at the edge of the shielding layer.

Existing designs also include a medium voltage transformer where the primary and secondary windings are separately dry cast to provide the required high voltage insulation. This concept can be used in inductors where the inductor winding is dry cast and is placed at a certain distance from the core. Some transformer designs address insulation requirements by using spacers to separate low and medium voltage windings.

All these existing structures can be dipped into oil to achieve the required partial discharge ratings and higher insulation, but since dry type magnetics is preferred in the medium voltage applications (wherever required) due in part to low maintenance, placing the magnetic structure inside oil may not be the most practical solution.

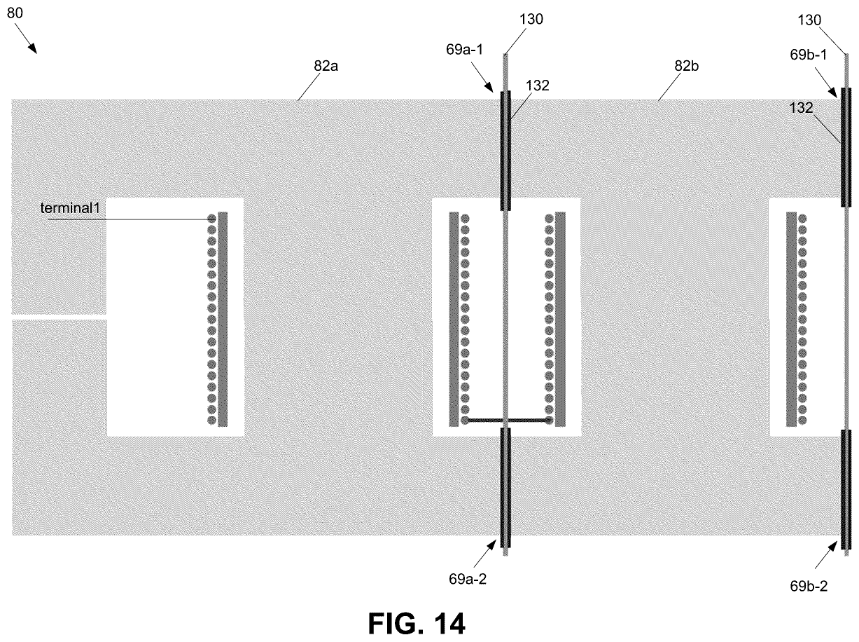

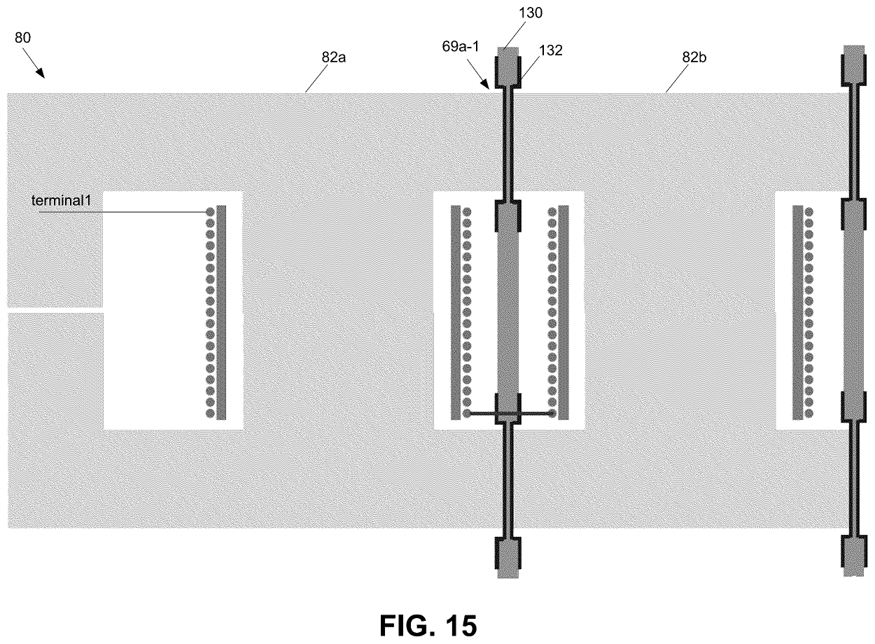

Referring now to FIGS. 13-15, shown is a portion of the matrix-based inductor 80 (though application to other embodiments disclosed herein similarly apply), where an insulation sheet 130 is inserted in the core gaps 69 (e.g., 69a-1, 69a-2, etc.) between adjacent cores 82 (e.g., 82a, 82b) to increase the clearance and creepage distances between the individual cores 82 while maintaining the required high voltage insulation. The thickness of the insulation sheet can be determined based on the material and the required insulation. In one embodiment, the material of the insulation sheet 130 includes polyamide, FR4, Nomex paper, or similar types of insulation material. In some cases, the core gap 69 is not enough to achieve the required insulation or achieve partial discharge free operation, and in such scenarios, the insulation sheet 130 needs to be introduced in the core gap 69 (shown in FIG. 13 running through the core gaps 69 and insulated space). However, inserting an insulation sheet directly in the gap without any other consideration, like as shown in FIG. 13, may result in a reduced partial discharge voltage. Hence, instead of just inserting the insulation sheet 130 in the core gaps 69 (which may still contain air pockets between the core 82 and the insulation sheet 130), the insulation sheet 130 is coated with a semiconductive paint or coating 132 on either side of the insulation sheet 130, as shown in FIG. 14. The cores 82 are then pressed against this insulation sheet 130 thus bringing the semiconductive paints 132 to the respective (different) core potentials. This method helps in increasing the clearance and the creepage due to the presence of the insulation sheet 130. The partial discharge capacity is improved by increasing the thickness of the insulation sheet 130 beyond (e.g., outside) the core gaps 69 as shown in FIG. 15.

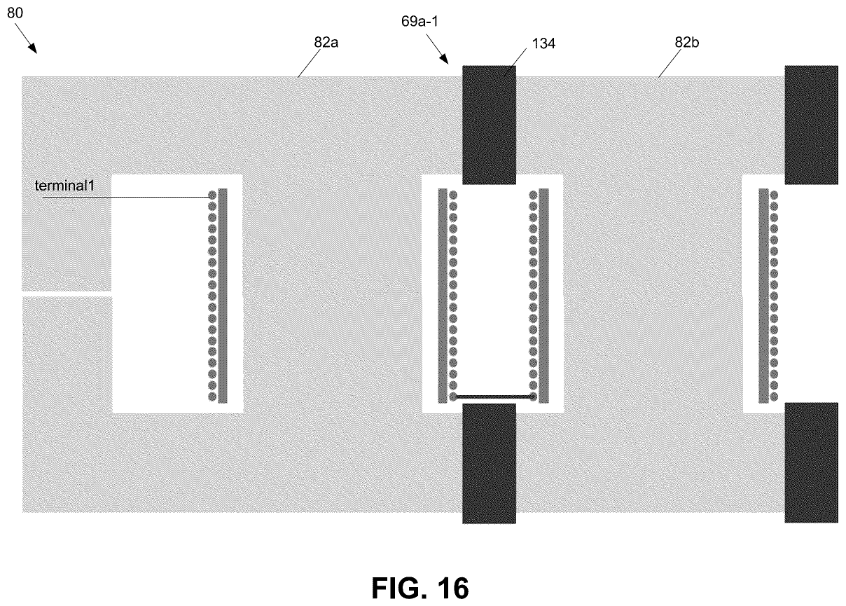

FIG. 16 shows yet another method to achieve the required clearance and creepage distance while maintaining a partial discharge free operation. In particular, FIG. 16 shows that encapsulation material 134 fills the core gaps 69 (e.g., 69a-1, etc.) that are disposed between adjacent cores 82 (e.g., 82a, 82b). That is, while the structure does not necessarily require encapsulation to achieve medium voltage insulation, the portions of the core 82 where the air gap (core gap 69) is provided can be encapsulated. The thickness and shape of the encapsulation material 134 depends on the required voltage insulation.

Although the applications of the SiC power devices in the field of medium voltage solid-state transformers have been described, the implementation of the embodiments of the inductors of the present disclosure is not limited to these medium voltage solid-state transformers with SiC power device. The embodiments of the inductors of the present disclosure may also be used in conventional power converters or other kinds of solid-state transformers using other kinds of power devices, such as Gallium Nitride (GaN) power devices or Silicon-based power devices.

Having described certain embodiments of a matrix-based inductor, and with reference to at least FIG. 6, it should be appreciated that one example first embodiment of an inductor (60), includes plural cores (62) including a first core (62a) and a second core (62b), the first core (62a) including a first center post (61a) and the second core (62b) including a second center post (61b), the first core (62a) is separated from the second core (62b) by a first gap (69a-1) that is dimensioned to enable a flux path with a value that is one-half a value of the flux through the first or second center posts.

The example first embodiment may include any one or combination of the following features.

For the inductor of the example first embodiment, the first core (62a) is configured to be at a different electrical potential than the second core.

For the inductor of the example first embodiment, dimensions of the first gap (69a-1) are determined based on specifications for inductance and insulation.

For the inductor of the example first embodiment, the plural cores (62) further include a third core (62c) adjacent to the second core (62b), the third core (62c) including a third center post (61c), the second core (62b) is separated from the third core (62c) by a second gap (69b-1), the second gap (69b-1) is dimensioned to enable a flux path with a value equal to the flux value of the first gap.

For the inductor of the example first embodiment, the first core includes a first core pair, the second core includes a second core pair, the first core pair are separated by a first center post gap (64a), and the second core pair are separated by a second center post gap (64b).

For the inductor of the example first embodiment, the first core includes a first core pair, the second core includes a second core pair, the first core pair are abutted against each other, and the second core pair are abutted against each other.

For the inductor of the example first embodiment, the plural cores include side posts (63), each of the side posts (63) includes a side post gap (68), and the side post gaps (68a, 68b) are oriented orthogonally to a direction of the first gap (69a-1).

For the inductor of the example embodiments, the plural cores include side posts (108), each of the side posts (108) includes a side post gap (106), the side post gaps (106a-1, 106a-2) are oriented parallel to a direction of the first gap (69a-1).

For the inductor of the example embodiments, the first core and the second core each includes a single body structure.

For the inductor of the example embodiments, the plural cores (102a, 102b, 102c, 102d) are arranged in a linear arrangement (120A).

For the inductor of the example embodiments, the plural cores (102a, 102e, 102g) are arranged in a non-linear arrangement (120B).

For the inductor of the example first embodiment, the first gap (69a-1) is occupied by an insulation sheet (130).

For the inductor of the example first embodiment, the insulation sheet further includes a semiconductive coating (132).

For the inductor of the example first embodiment, the insulation sheet with the semiconductive coating extends beyond the first gap.

For the inductor of the example first embodiment, the first gap includes an encapsulation material (134).

For the inductor of the example first embodiment, further including plural winding assemblies (66) insulated from the plural cores, the plural winding assemblies including a first winding assembly (66a) and a second winding assembly (66b), the first winding assembly including a first winding layer (35a) encircling the first center post, the second winding assembly including a second winding layer (35b) encircling the second center post.

For the inductor of the example first embodiment, the first and second winding layers include litz wire.

For the inductor of the example first embodiment, each of the first winding assembly and the second winding assembly includes a bobbin support (18).

With reference to at least FIG. 6, it should be appreciated that one example second embodiment of an inductor (60) includes plural cores (62), each including a core pair separated by a first gap (64) oriented along a first direction, each of the plural cores including a center post (61), the plural cores separated from each other by corresponding second gaps (69) oriented along a second direction that is orthogonal to the first direction, each of the second gaps dimensioned to enable a flux path with a value that is one-half a value of the flux through one of the center posts.

With reference to at least FIG. 8, it should be appreciated that one example third embodiment of an inductor (80) includes plural cores (82), each of the plural cores including a center post (84), the plural cores separated from each other by corresponding first gaps (69), each of the first gaps dimensioned to enable a flux path with a value that is one-half a value of the flux through one of the center posts.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. Note that various combinations of the disclosed embodiments may be used, and hence reference to an embodiment or one embodiment is not meant to exclude features from that embodiment from use with features from other embodiments. In the claims, the word “comprising” does not exclude other elements or steps, and the indefinite article “a” or “an” does not exclude a plurality.

At least the following is claimed:

1. An inductor, comprising:
plural cores comprising a first core and a second core, the first core comprising a first center post and the second core comprising a second center post, the first core separated from the second core by a first gap that is dimensioned to enable a flux path with a value that is one-half a value of the flux through the first or second center posts.

2. The inductor of claim 1, wherein the first core is configured to be at a different electrical potential than the second core.

3. The inductor of claim 1, wherein dimensions of the first gap are determined based on specifications for inductance and insulation.

4. The inductor of claim 1, wherein the plural cores further comprise a third core adjacent to the second core, the third core comprising a third center post, the second core separated from the third core by a second gap, the second gap dimensioned to enable a flux path with a value equal to the flux value of the first gap.

5. The inductor of claim 1, wherein the first core comprises a first core pair, the second core comprises a second core pair, the first core pair are separated by a first center post gap, and the second core pair are separated by a second center post gap.

6. The inductor of claim 1, wherein the first core comprises a first core pair, the second core comprises a second core pair, the first core pair are abutted against each other, and the second core pair are abutted against each other.

7. The inductor of claim 6, wherein the plural cores comprise side posts, each of the side posts comprising a side post gap, the side post gaps oriented orthogonally to a direction of the first gap.

8. The inductor of claim 6, wherein the plural cores comprise side posts, each of the side posts comprising a side post gap, the side post gaps oriented parallel to a direction of the first gap.

9. The inductor of claim 1, wherein the first core and the second core each comprises a single body structure.

10. The inductor of claim 1, wherein the plural cores are arranged in a linear arrangement.

11. The inductor of claim 1, wherein the plural cores are arranged in a non-linear arrangement.

12. The inductor of claim 1, wherein the first gap is occupied by an insulation sheet.

13. The inductor of claim 12, wherein the insulation sheet further comprises a semiconductive coating.

14. The inductor of claim 13, wherein the insulation sheet with the semiconductive coating extends beyond the first gap.

15. The inductor of claim 1, wherein the first gap comprises an encapsulation material.

16. The inductor of claim 1, further comprising plural winding assemblies insulated from the plural cores, the plural winding assemblies comprising a first winding assembly and a second winding assembly, the first winding assembly comprising a first winding layer encircling the first center post, the second winding assembly comprising a second winding layer encircling the second center post.

17. The inductor of claim 16, wherein the first and second winding layers comprise litz wire.

18. The inductor of claim 16, wherein each of the first winding assembly and the second winding assembly comprises a bobbin support.

19. An inductor, comprising:
plural cores, each comprising a core pair separated by a first gap oriented along a first direction, each of the plural cores comprising a center post, the plural cores separated from each other by corresponding second gaps oriented along a second direction that is orthogonal to the first direction, each of the second gaps dimensioned to enable a flux path with a value that is one-half a value of the flux through one of the center posts.

20. An inductor, comprising:
plural cores, each of the plural cores comprising a center post, the plural cores separated from each other by corresponding first gaps, each of the first gaps dimensioned to enable a flux path with a value that is one-half a value of the flux through one of the center posts.
